(19) United States
(12) Patent Application Publication
(10) Pub. No.: US 2003/0076215 A1
(43) Pub. Date: Apr. 24, 2003

(54) Inverted split-spool release devices

(76) Inventor: Varouj G. Baghdasarian, Cupertino, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 10/038,336

(22) Filed: Oct. 22, 2001

(51) Int. Cl. G05G 17/00; H01H 37/00

(52) U.S. Cl. 337/401; 337/1; 337/5; 337/140; 403/28

(57) ABSTRACT

Split spool release apparatus for retaining and deploying a deployable appendage. Exemplary apparatus comprises a housing which houses a split spool clamping device, a release nut attached to the deployable appendage, a locking mechanism or fuse assembly, and an actuator. The split spool clamping device comprises a plurality of separable sections that secure the release nut and deployable appendage using the restraining wire that is wrapped around them. In one embodiment, the split spool clamping device may comprises a threaded split-nut. The restraining wire is preferably wrapped using variable pretension, having low tension at the fuse end and higher tension at the nut end (load application end). The fuse assembly is coupled to the restraining wire at a location that is distal from the deployable appendage, and is activated by the actuator to release the restraining wire. This allows the separable sections of the split spool clamping device to separate and allow the release nut and deployable appendage to retract from the apparatus.

### BACKGROUND

The present invention relates generally to low shock release devices for deployable appendage hold down applications, and more particularly, to low shock release devices that may be used to stow and release items such as solar arrays, antenna positioning mechanisms, reflectors and the like, found on satellites, space stations, and spacecraft, for example.

The assignee of the present invention manufactures and deploys satellites that orbit the earth. The assignee of the present invention has previously developed a redundant fuse wire release device. This release device is disclosed in U.S. Pat. No. 6,133,818.

U.S. Pat. No. 6,133,818 discloses “A highly reliable release apparatus which is used to stow or release desired devices such as, for example, solar arrays, antenna positioning mechanisms, reflectors, found on satellites, space stations or spacecraft. Deployment of the desired device is prevented or allowed by respectively restraining or releasing a first member under tension. The apparatus comprises a support member having an opening and a first face arranged about the opening. A second member is located within the opening when the first member is in tension and is adapted to be attached to an end of the first member. At least three locking members such as fuse wires are arranged on the first face of said support member for restraining the second member within the opening in order to maintain tension on the first member. The second member is attached to the first member in a manner such that at least two of the fuse wires must be severed before the restraint on the second member is released. A system is provided for actuating the release apparatus by selectively severing at least two of the locking members when deployment of the device is desired.

It has been determined that the release device disclosed in U.S. Pat. No. 6,133,818 has a number of problems. The load to the fuse assembly creeps up with cyclic loading and potentially exceeding capability of the fuse assembly, therefore causing premature failure of the device both at the fuse assembly due to overload and at the restraining nut due to fatigue load.

Disadvantages of the release device disclosed in U.S. Pat. No. 6,133,818 include the following. A massive load is applied at the top requires structure to carry the load down to the base. The device has a large volume requirement. A critical section of the release nut threads are under tension, and therefore it has a limited fatigue life capability (failures have occurred during fatigue testing). Cyclic load creeps up to the fuse assembly, causing premature failure due to fuse overload. Spool surface without friction treatment does not provide sufficient reduction of force to the fuse, therefore causing fuse overload. Constant tension restraining wire wrap does not provide sufficient reduction of load to fuse assembly.

It would be advantageous to have low shock release devices that improve upon the design disclosed in U.S. Pat. No. 6,133,818.

### SUMMARY OF THE INVENTION

To meet the above and other objectives, the present invention provides for split spool release devices that improve upon the teachings of U.S. Pat. No. 6,133,818. An exemplary split spool release device comprises a cylinder cut in half, for example, and held together by a restraining wire wrapped around it. Inside the cylinder is a release nut used to hold down a deployable appendage. Upon release of the restraining wire, the two half-cylinders (spool halves) split apart, allowing the release nut to retract from the device.

A pre-load is applied to the half-cylinders (spool halves) through the release nut at the top side of the spool. The pre-load is resisted by restraining wire and is transferred down to a fuse assembly located at the bottom side of the device. Ultimate load to the fuse assembly is a function of spool geometry, number of restraining wire loops, friction between different components, initial pretension in the restraining wire, and applied load to the release nut.

The present invention prevents premature fuse failure by incorporating one or more of the following improvements or design changes to the device disclosed in U.S. Pat. No. 6,133,818. The present invention reduces the separation force applied to the spool halves at the load application point (top of the device in previous configuration) by inverting the spool and applying the load to the bottom side of the device. Having friction at the bottom between the spool bottom and the base plate reduces spool half separation, therefore the separation force, and therefore the load on the restraining wire. Consequently, this reduces the load on the fuse assembly. The present invention may also incorporate a friction coating between the restraining wire and the cylindrical surface of the spool. Friction coating material may be applied on the spool surface or on the restraining wire. The present invention may also wrap the restraining wire using variable pretension, by having low tension at the fuse end and higher tension at the nut end (load application end). Higher pretension creates higher frictional force, therefore more reduction in applied force before load gets to the fuse assembly.

The operating principals of the present device are substantially the same as the prior art split-spool device. The difference between the present device and the prior device is the way the load is carried down to the structure, and location of the fuse assembly. In the present device, the spool is inverted to bring the load application point down near the base of the structure, therefore taking advantage of friction at the base interface to resist the separation force, reducing the load to spool halves and the fuse. By inverting the spool, the load is applied directly to the base of the spool and carried directly to the support structure. This, therefore, eliminates the need for the body of the spool to be in the load path. As for the fuse assembly location, relocating it from the bottom to the top offers less interference with the spool operation, and possibly lower load on the fuse.

The use of a ball-to-cylindrical interface between the release nut and the spool offers more reliable release than the prior ball-to-cone design which has the potential for lock up at certain geometry and friction levels. The disadvantage of cylindrical interface is possibly in its higher cost of machining, but higher reliability is worth the additional cost.

The present invention inverts the spool and applies the load near the base, therefore reducing tip-over possibility of the spool halves during release. The present invention provides for a cylindrical ball-to-spool interface design compared to the cone used in the prior design disclosed in U.S. Pat. No. 6,133,818. Fuse assembly relocation offered packaging advantages, a smaller envelope and an interference-free spool function. The present invention has a less massive spool design because, the spool housing does not carry the application load. The load is already at the bottom of spool eliminating the need for a load transfer media to the base.

In the present invention, the direct load path to the housing eliminates the need for thicker and heavier structure, therefore reducing mass and volume. The use of the nut design employed in the present invention is less susceptible to fatigue failure since the critical section of nut threads are under compression. The present invention also provides for larger rotational misalignment capability for the nut compared to limited capability in the prior art.

The use of a frictional-material-coated spool surface prevents load creep to the fuse assembly, and therefore there is no overload. The variable tension wrapped restraining wire, with higher tension at the load end, creates higher frictional loads, therefore preventing load transfer to the weak link, the fuse assembly, and therefore prevents overload

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates release apparatus in accordance with the teachings of U.S. Pat. No. 6,133,818;

FIG. 2 illustrates the release apparatus of FIG. 1 in a released condition;

FIG. 3 illustrates a first exemplary embodiment of split spool release apparatus in accordance with the principles of the present invention;

FIG. 4 illustrates the exemplary split spool release apparatus in a released condition;

FIG. 5 illustrates a second exemplary embodiment of split spool release apparatus in accordance with the principles of the present invention; and

FIG. 6 illustrates details of the threaded nut used in the release apparatus of FIG. 5.

### DETAILED DESCRIPTION

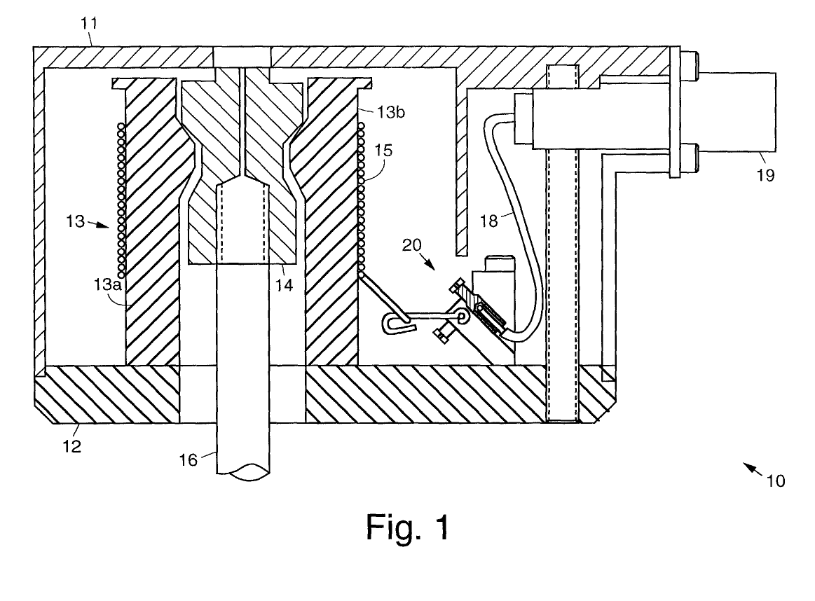

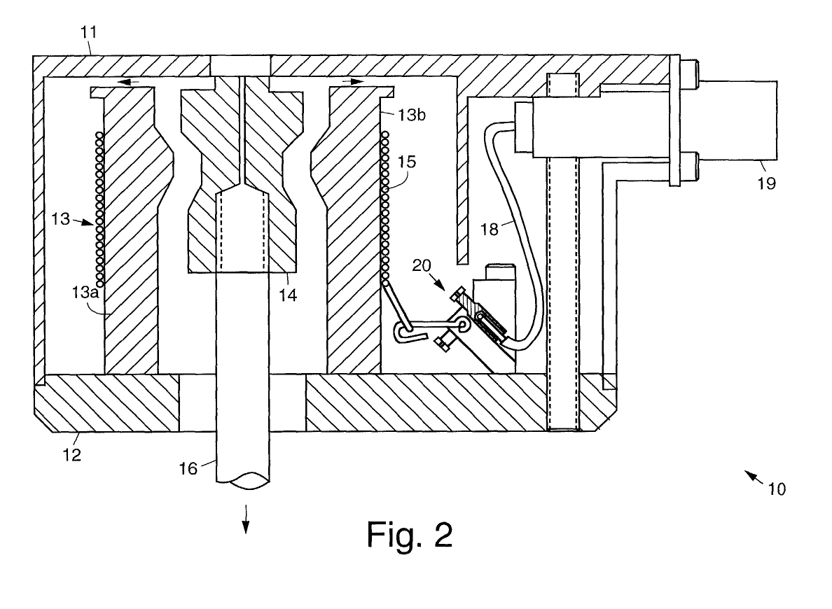

Referring to the drawing figures, FIG. 1 illustrates a prior art release apparatus 10 in accordance with the teachings of U.S. Pat. No. 6,133,818. FIG. 2 illustrates the release apparatus 10 shown in FIG. 1 in a released condition. FIGS. 1 and 2 are intended to generally illustrate the prior art release apparatus 10 so that the improvements provided by the present invention may be better understood. A better understanding of the prior art release apparatus 10 may be had with reference to U.S. Pat. No. 6,133,818, the contents of which are incorporated herein by reference in their entirety.

The release apparatus 10 controls the deployment of a device 16 (illustrated as a rod 16) that is attached to a release nut 14. Controlled deployment is achieved by restraining or releasing a tensioned member 15 (such as a wire 15 or a spring 15) under tension, which is tightly wrapped about a split spool clamping device 13, which retains the release nut 14 and respectively prevents or allows deployment of the device 16.

The split spool clamping device 13 has opposed first and second spool halves 13a, 13b arranged to clamp a portion of the device 16 to be deployed. A first end of the tensioned member 15 is attached to an upper end of the split spool clamping device 13. A base 12 supports the split spool clamping device 13 with an axis of the device 16 arranged normal to the base 12. A locking mechanism 20 comprising a fuse assembly extends from the base 12 in a direction normal to the base 12. A cover 11 is attached to the base 12.

As is detailed in U.S. Pat. No. 6,133,818, the locking mechanism 20 preferably comprises at least three fuse wires that may be severed or destroyed by melting to release the tensioned member 15. However, any desired non-explosive structures that may be severed by application of a signal such as a current may be used in the locking mechanism 20. Melting or severing of the fuse wires, for example, is implemented using an actuator 19 that is coupled to the locking mechanism 20 by way of electrical wires 18. The tensioned member 15 is captivated by the locking mechanism 20. The locking mechanism 20 restrains the tensioned member 15 to maintain tension on the tensioned member 15.

Operation of the release apparatus 10 is as follows. FIG. 1 shows the split spool clamping device 13 in its clamped position around the device 16. In this position the tensioned member 15 is tightly wrapped around the spool halves 13a, 13b of the split spool clamping device 13 which are held in alignment. The device 16 is attached to the release nut 14 which is clamped by the split spool clamping device 13 to prevent the release nut 14 and device 16 from deploying. When the release apparatus 10 is actuated by way of the actuator 19, the tensioned member 15 (wire 15) is released by the fuse wires 20. The tensioned member 15 uncoils and allows the halves 13a, 13b of the split spool clamping device 13 to separate as shown in FIG. 2, thereby releasing the holddown rod assembly (release nut 14 and device 16). Once the holddown rod assembly is released, a retraction spring or the deployment spring from the deploying appendage will retract the rod from the device housing with the deploying appendage.

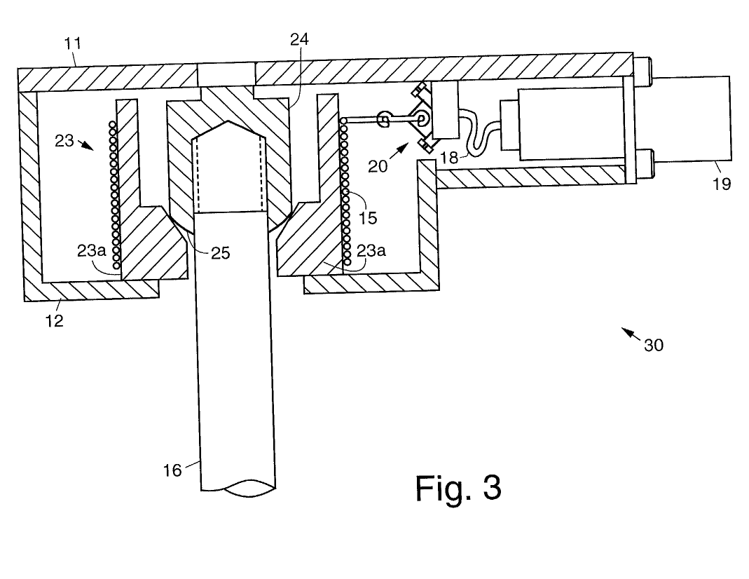

Referring now to FIG. 3, it illustrates a first exemplary embodiment of split spool release apparatus 30 in accordance with the principles of the present invention. As is shown in FIG. 3, the split spool release apparatus 30 is comprised of a housing 11, 12 comprising a base 12 and a cover 11 which houses a split spool clamping device 23, a release nut 24, a locking mechanism 20 or fuse assembly 20, and an actuator 19. The actuator 19 is coupled to the locking mechanism 20 or fuse assembly 20 by way of electrical wires 18.

The split spool clamping device 23 comprises a cylindrical member 23 that cut in half and held together by a restraining wire 15 wrapped around it. The restraining wire 15 may preferably be wrapped using variable pretension, by having low tension at the fuse end and higher tension at the nut end (load application end).

Inside the split spool clamping device 23 is the release nut 24 that is attached to the deployable appendage 16 and is used to hold down the deployable appendage 16. A bottom edge 25 or surface 25 (interface 25) of the release nut 24 of the split spool clamping device 23 is spherical or curved. Upon release of restraining wire 15, the two half-cylinders (spool halves 23a, 23b) of the split spool clamping device 23 are allowed to split apart allowing the release nut 24 (and deployable appendage 16) to be retracted from the apparatus 30.

The pre-load is applied to the spool halves 23a, 23b of the split spool clamping device 23 through the release nut 24 at one end of the split spool clamping device 23. The pre-load is resisted by restraining wire 15 and is transferred to a fuse assembly 20 located at an opposite end of the split spool clamping device 23. The ultimate load to the fuse assembly 20 is a function of the geometry of the split spool clamping device 23, number of loops of the restraining wire 15, friction between different components of the split spool clamping device 23, initial pretension in the restraining wire 15, and applied load to the release nut 24.

As for the interface between the spool halves 23a, 23b of the split spool clamping device 23 and the release nut 24, present invention employs cylindrical-to-spherical interface versus conical-to-spherical interface in the prior art. This offers a more reliable release function than the prior art design of U.S. Pat. No. 6,133,818.

The present split spool release apparatus 30 is inverted with respect to the split spool release device 10 disclosed in the U.S. Pat. No. 6,133,818. The inverted nature relates to the fact that the fuse wire used in the locking mechanism 20 or fuse assembly 20 is located at a distal end of the split spool clamping device 23 away from the deployable appendage 16, whereas in the device 10 disclosed in the U.S. Pat. No. 6,133,818, the fuse wire is attached at the opposite end of the split spool clamping device 23 close to the deployable appendage 16 (see FIG. 1).

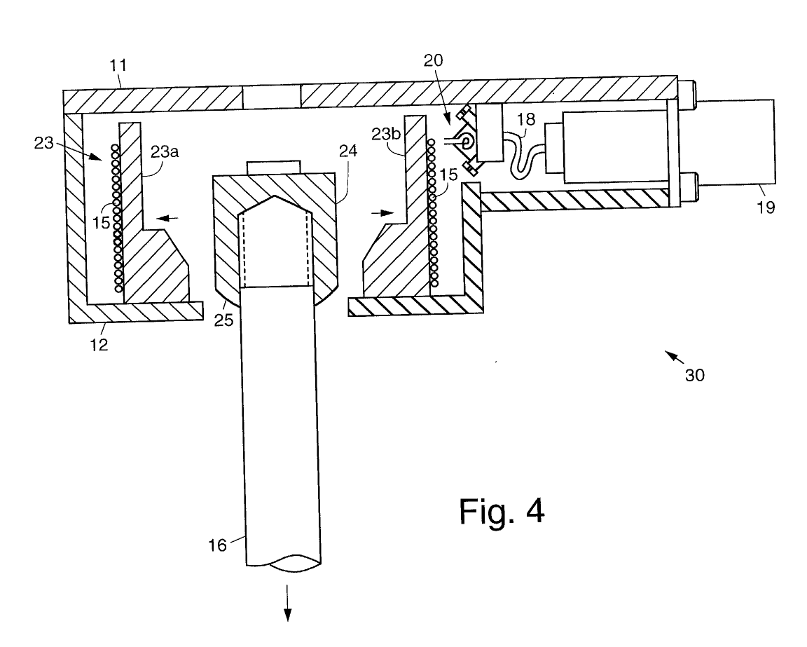

Operation of the split spool release apparatus 30 is generally similar to the prior art apparatus 10 discussed with reference to FIGS. 1 and 2. FIG. 4 illustrates the present split spool release apparatus 30 in a released condition. The fuse wire has been severed, releasing the restraining wire 15 so that spool halves 23a, 23b can separate from each other. This allows the release nut 24 and attached split spool clamping device 23 to separate from the apparatus 30.

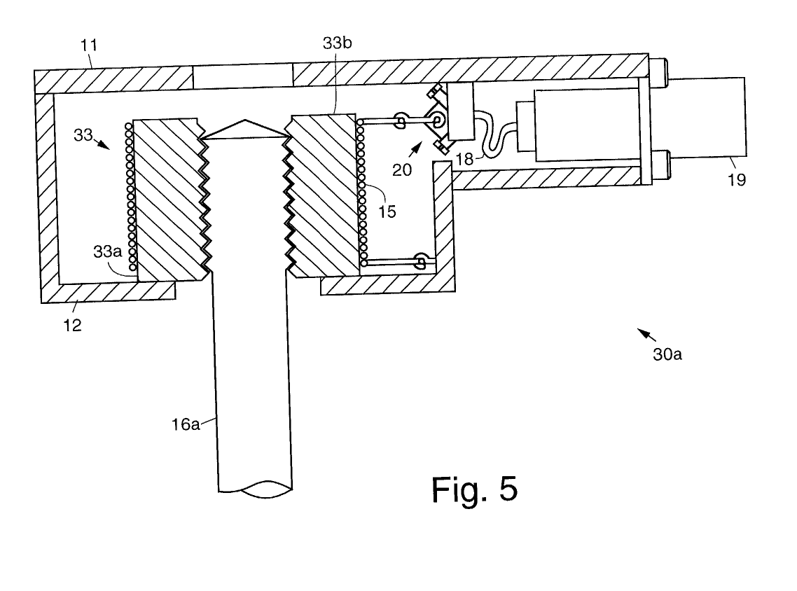

Referring now to FIG. 5, it illustrates a second exemplary embodiment of split spool release apparatus 30a in accordance with the principles of the present invention. The second embodiment of the split spool release apparatus 30a is substantially the same as the embodiment disclosed with reference to FIGS. 3 and 4, but employs a threaded split-nut 33 as a split spool clamping device 23. The threaded split-nut 33 has internal threads that captivate a threaded end of the deployable appendage 16. The threaded split-nut 33 has two or more sections 33a, 33b, such as in the manner as the split spool clamping device 23 shown in FIGS. 3 and 4. An advantage of the split-nut 24 concept is in its smaller physical size and ability to release without permanent local deformation due to point loading

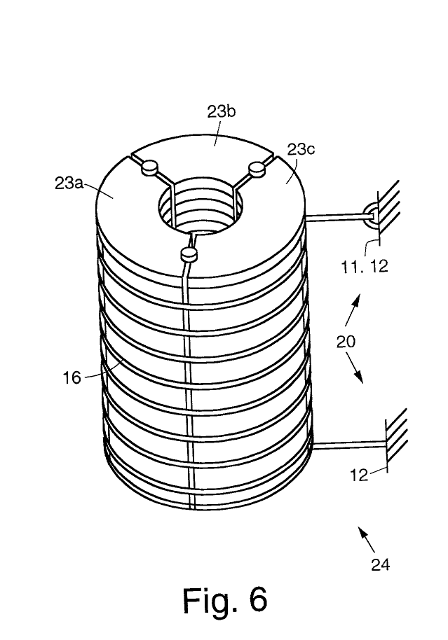

An exemplary threaded split-nut 33 may be made in three sections. FIG. 6 illustrates details of an exemplary three-section threaded split-nut 33 that may be used in the release apparatus 30a shown in FIG. 5. The three section threaded split-nut 33 has the restraining wire 15 wrapped around it. The restraining wire 15 at the bottom end of the threaded split-nut 33 is attached to the base 12. The restraining wire 15 is coupled to the fuse wire of the locking mechanism 20 or fuse assembly 20 which is attached to the cover 11 or an upper portion of the base 12 at the top of the threaded split-nut 33.

One possible failure mode of the present release apparatus 30, 30a is overloading of the fuse assembly 20. To limit the load to the fuse assembly 20 and preventing it from creeping up, the present invention preferably uses a high friction coating, such as tungsten carbide, for example, on cylindrical surfaces of spool halves 23a, 23b or the restraining wire at the restraining wire-to-spool interface. Application of the high friction coating to either the restraining or the spool surface helps resist transfer of load to the fuse assembly 20, therefore preventing premature failure of the device under either high load or cyclic load.

Thus, the present invention improves release apparatus that may be used to deploy an appendage. The present invention relocates the load application point from the top to the bottom of the spool. The present invention relocates the fuse from bottom to the top of the apparatus. The present invention selectively applies a frictional coating material on spool surface/interfaces to create more friction. The present invention selectively uses variable pre-tension on the restraining wire wrapping. Each of these aspects of the present invention improves its performance.

Thus, an improved split spool release device has been disclosed. It is to be understood that the described embodiment is merely illustrative of some of the many specific embodiments which represent applications of the principles of the present invention. Clearly, numerous and other arrangements can be readily devised by those skilled in the art without departing from the scope of the invention.

What is claimed is:

1. Split spool release apparatus for retaining and deploying a deployable appendage, comprising:
housing;
a split spool clamping device disposed on the housing that comprises a plurality of separable sections;
a release nut attached to the deployable appendage;
a restraining wire wrapped around the clamping device to secure the sections of the split spool clamping device to the release nut;
a fuse assembly coupled to the restraining wire at a location that is distal from the deployable appendage; and
an actuator coupled to the fuse assembly for selectively initiating the fuse assembly to release the restraining wire to allow the separable sections of the split spool clamping device to separate and allow the release nut and deployable appendage to retract from the apparatus.

2. The apparatus recited in claim 1 wherein the housing comprises a base and a cover.

3. The apparatus recited in claim 1 wherein the split spool clamping device is cylindrical in shape.

4. The apparatus recited in claim 1 wherein the split spool clamping device comprises two spool halves.

5. The apparatus recited in claim 1 wherein the split spool clamping device comprises two spool halves and wherein an interface between the spool halves and the restraining nut a spherical surface.

6. The apparatus recited in claim 1 wherein the split spool clamping device comprises a threaded split-nut.

7. The apparatus recited in claim 6 wherein the threaded split-nut has internal threads that captivate a threaded end of the deployable appendage.

8. The apparatus recited in claim 6 wherein the threaded split-nut comprises three sections.

9. The apparatus recited in claim 1 wherein the restraining wire is wrapped using variable pretension.

10. The apparatus recited in claim 9 wherein the variable pretension has low tension at a fuse end of the restraining wire and higher tension at a nut end or load application end of the restraining wire.

11. The apparatus recited in claim 2 wherein loads are carried directly to the base without transferring through the split spool clamping device to the fuse assembly.

12. The apparatus recited in claim 1 wherein the selected surfaces of the split spool clamping device are coated with a high friction material that increases the coefficient of friction between the split spool clamping device and the restraining wire.

13. The apparatus recited in claim 12 wherein the high friction material is tungsten carbide.

14. The apparatus recited in claim 1 wherein a surface of the restraining wire is coated with a high friction material that increases the coefficient of friction between the split spool clamping device and the restraining wire.

15. The apparatus recited in claim 14 wherein the high friction material is tungsten carbide.
